(19) United States
(12) Patent Application Publication
(10) Pub. No.: US 2024/0303990 A1
(43) Pub. Date: Sep. 12, 2024

(54) IMAGE PROCESSING APPARATUS, IMAGE PROCESSING METHOD, AND NON-TRANSITORY COMPUTER-READABLE MEDIUM

(71) Applicants: NEC Corporation, Minato-ku, Tokyo (JP); NEC Nexsolutions, Ltd., Minato-ku, Tokyo (JP)

(72) Inventors: Rika SUGIMOTO, Tokyo (JP); Mayu OKIYAMA, Tokyo (JP); Koji MATSUTOMI, Tokyo (JP); Takuo DAIKAKU, Tokyo (JP); Yohei HIROSE, Tokyo (JP)

(73) Assignees: NEC Corporation, Minato-ku, Tokyo (JP); NEC Nexsolutions, Ltd., Minato-ku, Tokyo (JP)

(21) Appl. No.: 18/282,845

(22) PCT Filed: Mar. 22, 2021
(86) PCT No.: PCT/JP2021/011656

§ 371 Date: Sep. 19, 2023

(51) Int. Cl. G06V 20/50; G06Q 30/0201; G06V 20/40

(52) U.S. Cl. CPC G06V 20/50; G06Q 30/0201; G06V 20/40

(57) ABSTRACT

An image processing apparatus (10) includes an image acquisition unit (110), an inference unit (120), and an output unit (130). The image acquisition unit (110) acquires an image from a terminal (20). This image includes a product in a part of its area. The inference unit (120) processes the image acquired by the image acquisition unit (110), and thereby generates subject inference data indicating an inference result of a type of an image capture subject. For example, the inference unit (120) processes an area around the product in the image, and thereby generates the subject inference data. The output unit (130) performs output based on the subject inference data.

### TECHNICAL FIELD

The present invention relates to an image processing apparatus, an image processing method, and a program.

### BACKGROUND ART

In recent years, a user can search for information concerning a product, by using, as a search key, an image including the product. For example, Patent Document 1 describes that a captured image of a product as a physical article or a catalog, or image data extracted from a moving image such as a television video are used as a search key. Patent Document 2 describes that images of products sourced from various advertisement media such as magazines, leaflets, pamphlets, posters, television commercials, advertisement moving images, and Web advertisements are used as search keys.

### RELATED DOCUMENT

### Patent Document

Patent Document 1: International Publication No. 2011/049209
Patent Document 2: Japanese Patent Application Publication No. 2017-33157

### SUMMARY OF INVENTION

### Technical Problem

There are a plurality of media that provide, to consumers, images including products. There is also a case where a consumer uses a captured image of a physical article for search. On the other hand, a degree of influence given on the behavior of a consumer by each of a physical article and media of an image is an important index from a standpoint of marketing. The inventors of the present invention considered that in order to estimate this degree of influence, it is necessary to infer an image capture subject at the time when a person generates an image including a product. One example of an object of the present invention is to infer an image capture subject at the time when a person generates an image including a product.

### Solution to Problem

According to the present invention, there is provided an image processing apparatus including:
an image acquisition unit that acquires an image that is a captured image of an image capture subject and includes a product in a part of an area;
an inference unit that processes the image and thereby generates subject inference data indicating an inference result of a type of the image capture subject; and
an output unit that performs output based on the subject inference data.

According to the present invention, there is provided an image processing method performing:
by a computer,
image acquisition processing of acquiring an image that is a captured image of an image capture subject and includes a product in a part of an area;
inference processing of processing the image and thereby generating subject inference data that indicate an inference result of a type of the image capture subject; and
output processing of performing output based on the subject inference data.

According to the present invention, there is provided a program causing a computer to perform:
image acquisition processing of acquiring an image that is a captured image of an image capture subject and includes a product in a part of an area;
inference processing of processing the image and thereby generating subject inference data that indicate an inference result of a type of the image capture subject; and
output processing of performing output based on the subject inference data.

### Advantageous Effects of Invention

According to the present invention, an image capture subject at the time when a person generates an image including a product can be inferred.

### BRIEF DESCRIPTION OF THE DRAWINGS

The object described above, other objects, features, and advantages will become further apparent from the preferred example embodiment described below and the accompanying drawings described below.

FIG. 1 It is a diagram for illustrating a use environment of an image processing apparatus according to an example embodiment.

FIG. 2 It is a diagram illustrating one example of a functional configuration of the image processing apparatus.

FIG. 3 It is a diagram for illustrating a first example of inference processing performed by an inference unit.

FIG. 4 It is a diagram for illustrating a second example of the inference processing performed by the inference unit.

FIG. 5 It is a diagram for illustrating the second example of the inference processing performed by the inference unit.

FIG. 6 It is a diagram for illustrating a third example of the inference processing performed by the inference unit.

FIG. 7 It is a diagram for illustrating a fourth example of the inference processing performed by the inference unit.

FIG. 8 It is a diagram illustrating one example of information stored in a person information storage unit.

FIG. 9 It is a diagram illustrating a first example of information output by an output unit.

FIG. 10 It is a diagram illustrating a second example of information output by the output unit.

FIG. 11 It is a diagram illustrating a hardware configuration example of the image processing apparatus.

FIG. 12 It is a flowchart illustrating one example of processing performed by the image processing apparatus, together with processing performed by a terminal.

### DESCRIPTION OF EMBODIMENTS

Hereinafter, an example embodiment of the present invention is described with reference to the drawings. Note that, in all the drawings, the similar constituent elements are denoted by similar reference signs, and the description thereof will not be repeated as appropriate.

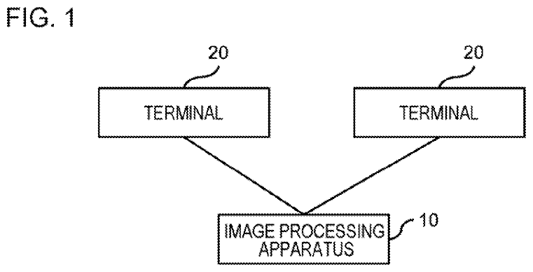

FIG. 1 is a diagram for illustrating a use environment of an image processing apparatus 10 according to the example embodiment. The image processing apparatus 10 is used together with a terminal 20.

The terminal 20 is, for example, a portable terminal such as a smartphone or a tablet terminal, and is operated by a person. In accordance with this operation, the terminal 20 transmits an image to the image processing apparatus 10. This image is generated by capturing an image of an image capture subject, and includes a product in a part of an area thereof. Herein, one example of the image capture subject is a product (physical article) arranged in a physical space such as a store, and a medium including an image of the product. Herein, examples of the medium include printed matters such as magazines and advertisements, screens displayed on displays, based on broadcast, screens displayed on displays, based on a social networking service (SNS), and screens displayed on displays, based on emails. The printed matters include also advertisements arranged in streets. Note that, the image that the terminal 20 transmits to the image processing apparatus 10 may be a still image or a moving image.

When the image processing apparatus 10 acquires an image from the terminal 20, the image processing apparatus 10 processes this image, and thereby generates data (hereinafter, referred to as subject inference data) indicating an inference result of a type of the image capture subject. The image processing apparatus 10 performs output based on the subject inference data. This output may be output of the subject inference data themselves. When there are a plurality of the terminals 20 and a plurality of pieces of subject inference data are generated, the output unit 130 may output a result of statistical processing of the subject inference data.

The image processing apparatus 10 processes an image acquired from the terminal 20, and thereby infers a product included in the image. Then, the image processing apparatus 10 executes at least a part of processing for allowing a user of the terminal 20 to purchase the product.

Note that, the terminal 20 may have an image capturing function. In this case, the terminal 20 may generate an image to be transmitted to the image processing apparatus 10.

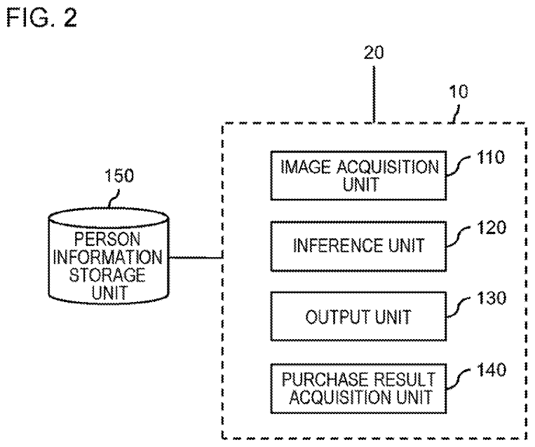

FIG. 2 is a diagram illustrating one example of a functional configuration of the image processing apparatus 10. The image processing apparatus 10 includes an image acquisition unit 110, an inference unit 120, and the output unit 130.

The image acquisition unit 110 acquires an image from the terminal 20. This image includes a product in a part of an area thereof, as described above.

The inference unit 120 processes an image acquired by the image acquisition unit 110, and thereby generates the above-described subject inference data. For example, the inference unit 120 processes an area around a product in the image, and thereby generates the subject inference data. When the image is a moving image, the inference unit 120 processes a plurality of frame images included in the moving image, and thereby generates the subject inference data. Details of the subject inference data generation processing are described below with reference to other drawings.

The inference unit 120 processes an image acquired by the image acquisition unit 110, and thereby infers a product included in this image. At this time, the inference unit 120 may further infer a product (hereinafter, referred to as a similar product) similar to this product. This inference result includes, for example, at least one of a product name and a product code (e.g., a JAN code). Note that, this inference processing may be performed by feature amount matching, for example, or may be performed with a model generated by machine learning.

Then, depending on necessity, the inference unit 120 performs at least a part of processing necessary for a user of the terminal 20 to purchase this product and/or the similar product. One example of this processing is to determine an online shop and/or a physical store where this product and/or the similar product can be purchased, and to transmit, to the terminal 20, information (hereinafter, referred to as purchase assistance information) determining this online shop and/or the physical store. The purchase assistance information may include a URL of or a link to the online shop, or may include information (e.g., an address and/or a map) indicating a location of the physical store. Further, the purchase assistance information may include advertisement information or coupon information concerning the product and/or the similar product inferred by the inference unit 120. In the determination of the online shop and/or the physical store, the inference unit 120 uses the above-described inference result, i.e., at least one of the product name and the product code.

Note that, the inference unit 120 stores, in a person information storage unit 150, information indicating the inference result, in association with the user of the terminal 20. Details of information stored in the person information storage unit 150 are described below with reference to other drawings. The person information storage unit 150 may be a part of the image processing apparatus 10, or may be located outside the image processing apparatus 10.

The output unit 130 performs output based on the subject inference data. As described above, this output may be output of the subject inference data themselves. When there are a plurality of the terminals 20, the inference unit 120 generates the subject inference data for each of a plurality of the terminals 20. In this case, the output unit 130 may statistically process a plurality of pieces of the subject inference data, and thereby generate output data. In this case, one example of the output data is data (hereinafter, referred to as first relation data) indicating a relation between attribute information of a user of each of a plurality of the terminals 20 and the subject inference data. The attribute information of the user of each of a plurality of the terminals 20 is stored in the person information storage unit 150. Using the first relation data enables a preferred image capture subject to be determined for each of age groups (or genders). A specific example of output performed by the output unit 130 is described below with reference to other drawings.

The image processing apparatus 10 further includes a purchase result acquisition unit 140. The purchase result acquisition unit 140 acquires information (hereinafter, referred to as purchase result information) indicating whether a product included in the image acquired by the image acquisition unit 110 has been purchased. The purchase result acquisition unit 140 acquires the purchase result information from the terminal 20, for example, but may acquire the purchase result information from another apparatus (e.g., a server that manages an online shop or a physical store). The information acquired by the purchase result acquisition unit 140 is stored in the person information storage unit 150.

Then, the output unit 130 outputs data (hereinafter, referred to as second relation data) indicating a relation between the subject inference data and the purchase result information. At this time, the output unit 130 uses the information stored in the person information storage unit 150. By using the second relation data, a user of the image processing apparatus 10 can recognize to what extent the image capture subject leads to the purchase.

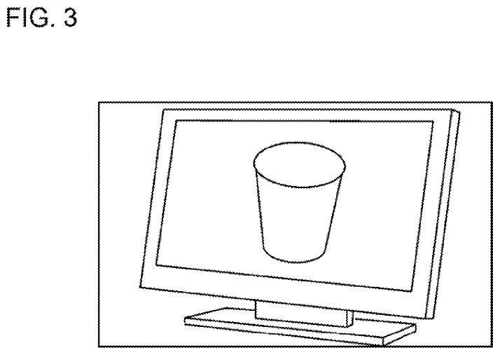

FIG. 3 is a diagram for illustrating a first example of the inference processing performed by the inference unit 120. In the example illustrated in the present drawing, the image capture subject is a screen displayed on a display, based on radio-wave or online broadcast. This display may be used as a television, or may be used as digital signage. When an image including a product is displayed on this display, a user of the terminal 20 causes the terminal 20 to capture an image of a screen of this display. The terminal 20 may generate a still image, or may generate a moving image. The image generated by the terminal 20 captures a frame of the display in one case, or captures only the screen of the display without capturing this frame in another case. In the former case, the inference unit 120 detects the frame of the display, and thereby determines that the image capture subject is the display. In the latter case, the inference unit 120 determines that the image capture subject is the display, when the image includes a scanning line particular to a display.

When the terminal 20 has generated a moving image, the inference unit 120 processes this moving image, and thereby, can also determine a type (e.g., an advertisement aired on television broadcast, or an advertisement played on digital signage) of contents displayed on the display. This also enables the inference unit 120 to determine the image capture subject.

When the image includes an edge of the display, the inference unit 120 detects a feature amount of a part outside the display in the image, performs matching processing on this feature amount, and can thereby determine a place where the display is arranged (e.g., whether the place is the indoor or the outdoor).

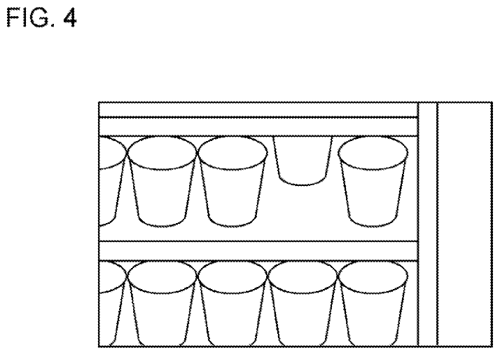

FIG. 4 is a diagram for illustrating a second example of the inference processing performed by the inference unit 120. In the example illustrated in the present drawing, the image capture subject is a product as a physical article. In this case, the terminal 20 preferably has generated a moving image. Then, the inference unit 120 determines that the image capture subject is a product as a physical article when at least a part of surroundings of the product has changed, and determines that the image capture subject is a printed matter such as a magazine when the surroundings of the product have not changed.

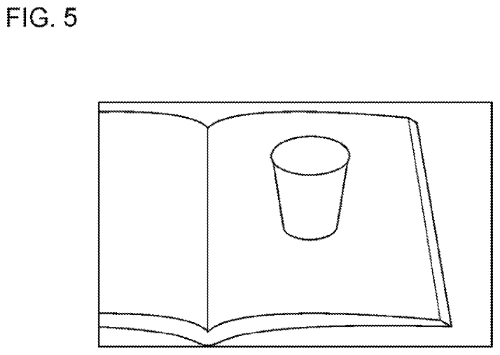

Note that, as illustrated in FIG. 5, when the image capture subject is a printed matter, there is a case where an edge of the magazine is captured in the printed matter generated by the terminal 20. When the inference unit 120 detects this edge, the inference unit 120 determines that the image capture subject is a printed matter.

When the edge of the printed matter is included in the image, the inference unit 120 processes a part outside the printed matter in the image, and can thereby determine a place where the printed matter is arranged (whether the place is the indoor or the outdoor).

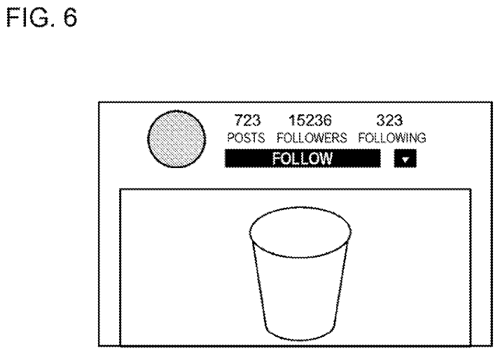

FIG. 6 is a diagram for illustrating a third example of the inference processing performed by the inference unit 120. In the example illustrated in the present drawing, the image capture subject is a screen displayed on a display, based on an SNS. In this case, this screen includes a screen configuration particular to SNSs. The inference unit 120 detects presence or absence of this screen configuration, and can thereby determine that the image capture subject is an SNS and determine also a service name of the SNS.

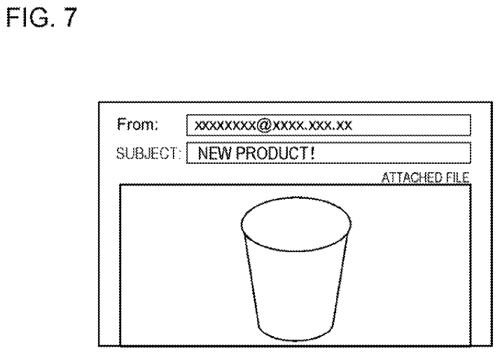

FIG. 7 is a diagram for illustrating a fourth example of the inference processing performed by the inference unit 120. In the example illustrated in the present drawing, the image capture subject is a screen displayed on a display based on an email. In this case, this screen includes a screen configuration particular to emails. The inference unit 120 detects presence or absence of this screen configuration, and can thereby determine that the image capture subject is an email.

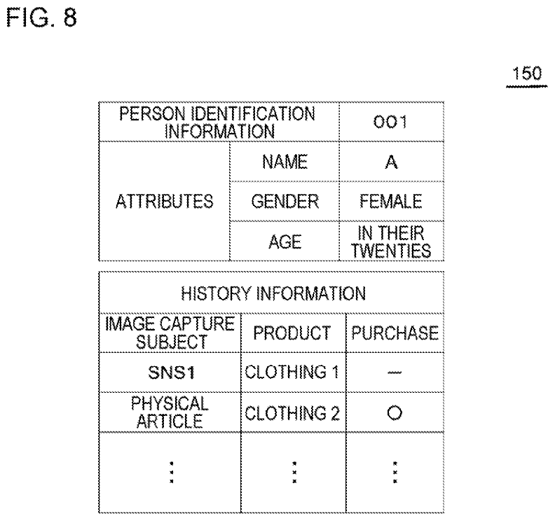

FIG. 8 is a diagram illustrating one example of information stored in the person information storage unit 150 of the image processing apparatus 10. In the example illustrated in the present drawing, the person information storage unit 150 stores, in association with one another, identification information (hereinafter, referred to as person identification information) assigned to the person, attribute information, and history information, for each of persons.

The attribute information includes a name, a gender, and an age of the person, but may include other information.

The history information includes a result of analysis made by the inference unit 120 on an image that the person have sent from the terminal 20. The analysis result of the inference unit 120 includes an image capture subject, and a product name and/or a product code. The history information includes also information indicating whether the product inferred by the inference unit 120 has been purchased. Note that, the history information may further include information determining a date and a time of the purchase of the product, and an online shop or a physical store where the product has been sold.

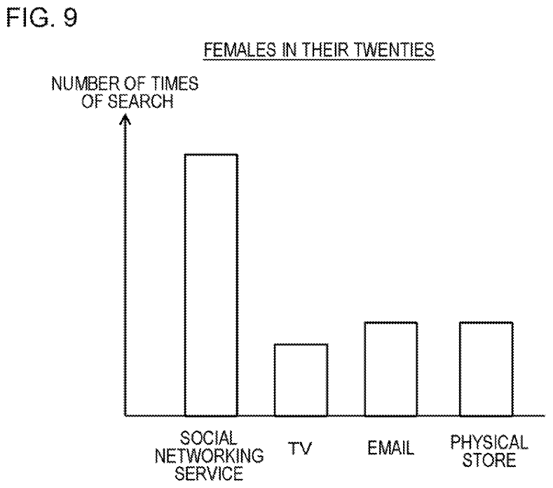

FIG. 9 is a diagram illustrating a first example of information output by the output unit 130 of the image processing apparatus 10. In the example illustrated in the present drawing, the output unit 130 outputs first relation data. As described above, the first relation data indicate a relation between attribute information of a user of each of a plurality of the terminals 20 and the subject inference data. In the example illustrated in the present drawing, the first relation data indicate, for each of attributes, the number of times of use of an image capture subject used in search by the person having the attribute. The information illustrated in the present drawing may be sorted by each product name or each product code, or may be sorted by each category of products. Herein, the categories of products may be general categories such as clothing and food for example, or may be specific categories such as coats and shirts.

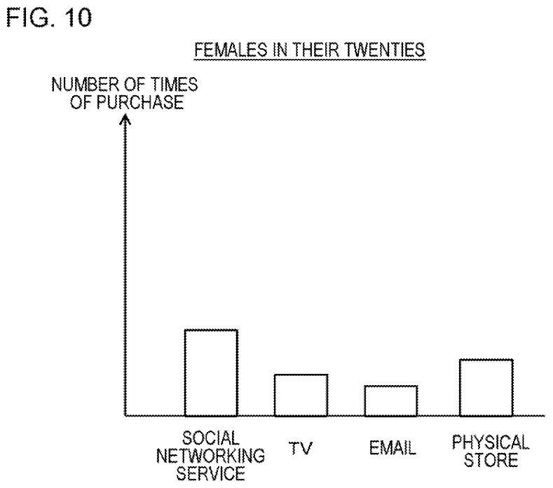

FIG. 10 is a diagram illustrating a second example of information output by the output unit 130 of the image processing apparatus 10. In the example illustrated in the present drawing, the output unit 130 outputs second relation data. As described above, the second relation data indicate a relation between subject inference data and purchase result information. In the example illustrated in the present drawing, the second relation data indicate, for each of attributes, the number of times of use of an image capture subject used by persons who have consequently purchased products. The information illustrated in the present drawing may also be sorted by each product name or each product code, or may be sorted by each category of products.

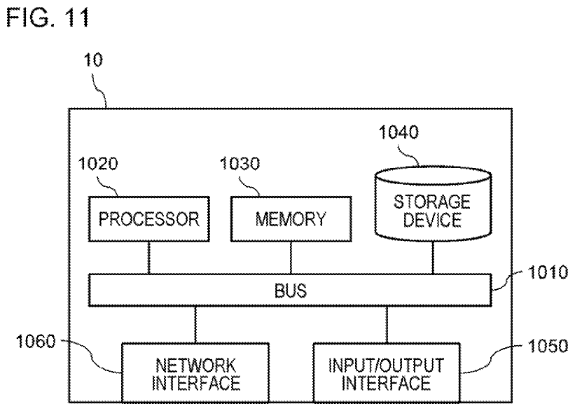

FIG. 11 is a diagram illustrating a hardware configuration example of the image processing apparatus 10. The image processing apparatus 10 includes a bus 1010, a processor 1020, a memory 1030, a storage device 1040, an input/output interface 1050, and a network interface 1060.

The bus 1010 is a data transmission path through which the processor 1020, the memory 1030, the storage device 1040, the input/output interface 1050, and the network interface 1060 mutually transmit and receive data. However, a method of connecting the processor 1020 and the like to one another is not limited to bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage apparatus implemented by a hard disk drive (HDD), a solid state drive (SSD), a memory card, a read only memory (ROM), or the like. The storage device 1040 stores a program module that implements each function (e.g., the image acquisition unit 110, the inference unit 120, the output unit 130, and the purchase result acquisition unit 140) of the image processing apparatus 10. The processor 1020 reads each of these program modules onto the memory 1030 and executes the read program module, and thereby, each function associated with the program module is implemented. In addition, the storage device 1040 functions also as the person information storage unit 150.

The input/output interface 1050 is an interface for connecting the image processing apparatus 10 and various pieces of input/output equipment to each other.

The network interface 1060 is an interface for connecting the image processing apparatus 10 to a network. This network is a local area network (LAN) or a wide area network (WAN), for example. A method for connecting the network interface 1060 to the network may be wireless connection, or may be wired connection. The image processing apparatus 10 may communicate with the terminal 20 via the network interface 1060.

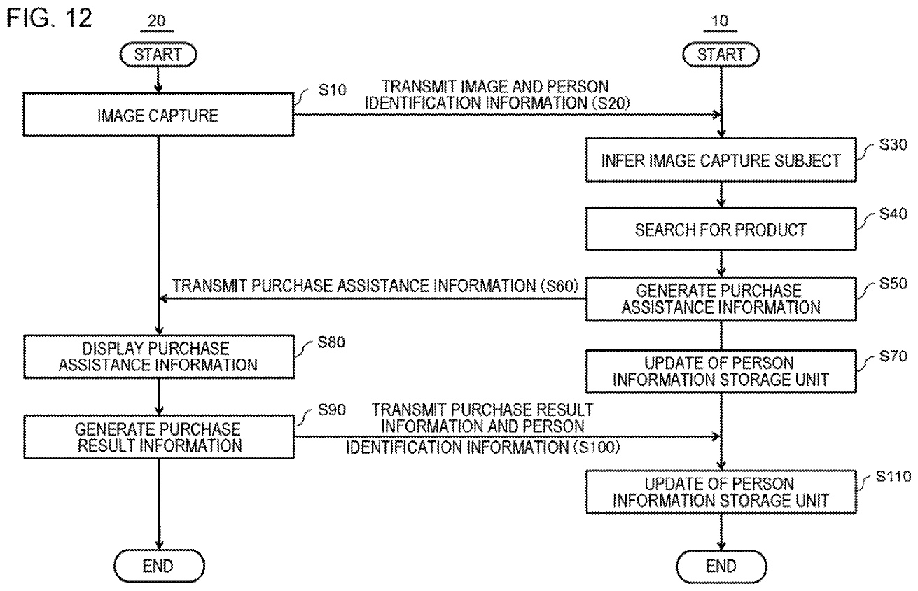

FIG. 12 is a flowchart illustrating one example of processing performed by the image processing apparatus 10, together with processing performed by the terminal 20.

When a user of the terminal 20 finds a product that interests him or her, the user causes the terminal 20 to generate an image including the product (step S10). Herein, one example of the image capture subject whose image is captured by the terminal 20 is described above with reference to FIG. 1. Then, the terminal 20 transmits the captured image to the image processing apparatus 10. At this time, the terminal 20 transmits also person identification information of the user to the image processing apparatus 10 (step S20).

The image acquisition unit 110 of the image processing apparatus 10 acquires the image transmitted from the terminal 20. Then, the inference unit 120 processes this image, and thereby infers the image capture subject (step S30). One example of the processing performed herein is described above with reference to FIG. 2 to FIG. 7.

The inference unit 120 processes this image, and thereby determines the product included in the image, and/or a similar product thereof (step S40). Then, the inference unit 120 determines an online shop and/or a physical store where this product and/or the similar product can be purchased, and generates information concerning this online shop and/or the physical store, i.e., purchase assistance information (step S50). Then, the inference unit 120 transmits this purchase assistance information to the terminal 20 (step S60).

The inference unit 120 stores, in the person information storage unit 150, in association with each other, the image capture subject inferred at the step S30 and information (e.g., at least one of a product name and a product code) indicating the product and/or the similar product determined at the step S40. At this time, the inference unit 120 associates these pieces of information with the person identification information transmitted at the step S20 (step S70).

When the terminal 20 acquires the purchase assistance information from the image processing apparatus 10, the terminal 20 displays the purchase assistance information on the display (step S80). In a case of purchasing a product, the user of the terminal 20 uses this purchase assistance information.

The terminal 20 generates information (hereinafter, referred to as purchase result information) indicating whether the product has been purchased (step S90), and transmits this purchase result information to the image processing apparatus 10, together with the person identification information (step S100). Depending on necessity, the purchase result information includes information determining a date and a time of the purchase and an online shop or a physical store where the product has been sold.

The purchase result acquisition unit 140 of the image processing apparatus 10 stores, as a part of history information in the person information storage unit 150, the purchase result information transmitted from the terminal 20. At this time, the purchase result acquisition unit 140 associates the purchase result information with the person identification information transmitted at the step S100 (step S110).

After that, the output unit 130 of the image processing apparatus 10 generates and outputs the output data at a necessary timing.

As described above, according to the present example embodiment, the image processing apparatus 10 infers an image capture subject at the time when a person generates an image including a product. Accordingly, using this inference result enables estimation of a degree of influence that has been given on the behavior of a consumer by a product as a physical article or a medium providing a product image. This degree of influence is indicated by the above-described first relation data and second relation data, for example.

Although the example embodiment of the present invention is described above with reference to the drawings, these described matters are exemplifications of the present invention, and various configurations other than those described above can also be employed.

In addition, in a plurality of the flowcharts used in the above description, a plurality of the steps (pieces of processing) are described in order, but the execution order of the steps executed in each example embodiment is not limited to the described order. In each example embodiment, the order of the illustrated steps can be changed within a range in which inconvenience does not occur in the contents. The above-described each example embodiment can be combined within a range in which contradiction does not occur in the contents.

A part or all of the above-described example embodiment can also be described as in the following supplementary notes, but there is no limitation to the following.
1. An image processing apparatus including:
   an image acquisition unit that acquires an image that is a captured image of an image capture subject and includes a product in a part of an area;
   an inference unit that processes the image and thereby generates subject inference data indicating an inference result of a type of the image capture subject; and
   an output unit that performs output based on the subject inference data.
2. The image processing apparatus according to the supplementary note 1, in which
   the inference unit generates the subject inference data by processing an area around the product in the image.
3. The image processing apparatus according to the supplementary note 1 or 2, in which
   the image acquisition unit acquires, as the image, a moving image, and
   the inference unit processes a plurality of frame images included in the moving image, and thereby generates the subject inference data.
4. The image processing apparatus according to any one of the supplementary notes 1 to 3, in which
   a type of the image capture subject includes at least one of: a screen displayed on a display, based on broadcast; a screen displayed on a display, based on a social networking service (SNS); a screen displayed on a display, based on an email; a printed matter; and the product arranged in a physical space.
5. The image processing apparatus according to any one of the supplementary notes 1 to 4, in which
   the image is generated by a terminal,
   the image acquisition unit acquires the image from a plurality of the terminals,
   the inference unit generates the subject inference data for each of the plurality of terminals, and
   the output unit outputs first relation data indicating a relation between attribute information of a user of each of the plurality of terminals and the subject inference data.
6. The image processing apparatus according to any one of the supplementary notes 1 to 5, in which
   the inference unit further processes the image, and thereby infers the product and/or a similar product similar to the product.
7. The image processing apparatus according to the supplementary note 6, further including:
   a purchase result acquisition unit that acquires purchase result information indicating whether the product and/or the similar product has been purchased, in which
   the output unit outputs second relation data indicating a relation between the subject inference data and the purchase result information.
8. An image processing method performing:
   by a computer,
   image acquisition processing of acquiring an image that is a captured image of an image capture subject and includes a product in a part of an area;
   inference processing of processing the image and thereby generating subject inference data that indicate an inference result of a type of the image capture subject; and
   output processing of performing output based on the subject inference data.
9. The image processing method according to the supplementary note 8, performing:
   by the computer,
   in the inference processing, processing an area around the product in the image and thereby generating the subject inference data.
10. The image processing method according to the supplementary note 8 or 9, performing:
   by the computer,
   in the image acquisition processing, acquiring, as the image, a moving image; and
   in the inference processing, processing a plurality of frame images included in the moving image, and thereby generating the subject inference data.
11. The image processing method according to any one of the supplementary notes 8 to 10, in which
   a type of the image capture subject includes at least one of: a screen displayed on a display, based on broadcast; a screen displayed on a display, based on a social networking service (SNS); a screen displayed on a display, based on an email; a printed matter; and the product arranged in a physical space.
12. The image processing method according to any one of the supplementary notes 8 to 11, in which
   the image is generated by a terminal, and
   the method performs:
   by the computer,
   in the image acquisition processing, acquiring the image from a plurality of the terminals;
   in the inference processing, generating the subject inference data for each of the plurality of terminals; and
   in the output processing, outputting first relation data that indicate a relation between attribute information of a user of each of the plurality of terminals and the subject inference data.
13. The image processing method according to any one of the supplementary notes 8 to 12, performing:
   by the computer,
   in the inference processing, further processing the image, and thereby inferring the product and/or a similar product similar to the product.
14. The image processing method according to the supplementary note 13, further performing:
   by the computer,
   purchase result acquisition processing of acquiring purchase result information that indicates whether the product and/or the similar product has been purchased; and
   in the output processing, outputting second relation data that indicate a relation between the subject inference data and the purchase result information.
15. A program causing a computer to perform:
   image acquisition processing of acquiring an image that is a captured image of an image capture subject and includes a product in a part of an area;
   inference processing of processing the image and thereby generating subject inference data that indicate an inference result of a type of the image capture subject; and
   output processing of performing output based on the subject inference data.
16. The program according to the supplementary note 15, in which
   the inference function processes an area around the product in the image, and thereby generates the subject inference data.
17. The program according to the supplementary note 15 or 16, in which,
   the image acquisition function acquires, as the image, a moving image, and
   the inference function processes a plurality of frame images included in the moving image, and thereby generates the subject inference data.
18. The program according to any one of the supplementary notes 15 to 17, in which
   a type of the image capture subject includes at least one of: a screen displayed on a display, based on broadcast; a screen displayed on a display, based on a social networking service (SNS); a screen displayed on a display, based on an email; a printed matter; and the product arranged in a physical space.
19. The program according to any one of the supplementary notes 15 to 18, in which
   the image is generated by a terminal,
   the image acquisition function acquires the image from a plurality of the terminals,
   the inference function generates the subject inference data for each of the plurality of terminals, and
   the output function outputs first relation data that indicate a relation between attribute information of a user of each of the plurality of terminals and the subject inference data.
20. The program according to any one of the supplementary notes 15 to 19, in which
   the inference function further processes the image, and thereby infers the product and/or a similar product similar to the product.
21. The program according to the supplementary note 20, causing the computer to further include:
   a purchase result acquisition function of acquiring purchase result information that indicates whether the product and/or the similar product has been purchased, in which
   the output function outputs second relation data that indicate a relation between the subject inference data and the purchase result information.

### REFERENCE SIGNS LIST

10 Image processing apparatus
20 Terminal
110 Image acquisition unit
120 Inference unit
130 Output unit
140 Purchase result acquisition unit
150 Person information storage unit

What is claimed is:

1. An image processing apparatus comprising:
at least one memory configured to store instructions; and
at least one processor configured to execute the instructions to perform operations, the operations comprising:
acquiring an image that is a captured image of an image capture subject and includes a product in a part of an area;
processing the image and thereby generating subject inference data indicating an inference result of a type of the image capture subject; and
performing output based on the subject inference data.

2. The image processing apparatus according to claim 1, wherein
the operations further comprise generating the subject inference data by processing an area around the product in the image.

3. The image processing apparatus according to claim 1, wherein the operations further comprise
acquiring, as the image, a moving image, and
processing a plurality of frame images included in the moving image, and thereby generating the subject inference data.

4. The image processing apparatus according to claim 1, wherein
a type of the image capture subject includes at least one of: a screen displayed on a display, based on broadcast; a screen displayed on a display, based on a social networking service (SNS); a screen displayed on a display, based on an email; a printed matter; and the product arranged in a physical space.

5. The image processing apparatus according to claim 1, wherein
the image is generated by a terminal,
the operations further comprise
acquiring the image from a plurality of the terminals,
generating the subject inference data for each of the plurality of terminals, and
outputting first relation data indicating a relation between attribute information of a user of each of the plurality of terminals and the subject inference data.

6. The image processing apparatus according to claim 1, wherein
the operations further comprise processing the image, and thereby inferring the product and/or a similar product similar to the product.

7. The image processing apparatus according to claim 6, wherein the operations further comprise
acquiring purchase result information indicating whether the product and/or the similar product has been purchased, and
outputting second relation data indicating a relation between the subject inference data and the purchase result information.

8. An image processing method performing:
by a computer,
acquiring an image that is a captured image of an image capture subject and includes a product in a part of an area;
processing the image and thereby generating subject inference data that indicate an inference result of a type of the image capture subject; and
performing output based on the subject inference data.

9. A non-transitory computer-readable medium storing a program for causing a computer to perform operations, the operations comprising:
acquiring an image that is a captured image of an image capture subject and includes a product in a part of an area;
processing the image and thereby generating subject inference data that indicate an inference result of a type of the image capture subject; and
performing output based on the subject inference data.
